(19) United States
(12) Patent Application Publication
(10) Pub. No.: US 2006/0202477 A1
(43) Pub. Date: Sep. 14, 2006

(54) Pipe fixing system

(76) Inventor: Sukyoon Kim, Incheon (KR)

Correspondence Address: IPLA P.A., 3580 WILSHIRE BLVD., 17TH FLOOR, LOS ANGELES, CA, 90010, US

(21) Appl. No.: 10/554,263

(22) PCT Filed: Apr. 24, 2004
(86) PCT No.: PCT/KR04/00949

§ 371 Date: Oct. 25, 2005

(30) Foreign Application Priority Data
Apr. 25, 2003 (KR) 20-2003-0013609

(51) Int. Cl. F16L 37/00

(52) U.S. Cl. 285/307

(57) ABSTRACT

The present invention discloses a pipe structure fixing device, which can easily and rapidly fix and remove a pipe. The pipe structure-fixing device includes: a body (20) having a stopping part (21) formed on the lower portion of the inside thereof for stopping the pipe (10) inserted into the body (20), an extended portion extended partially upwardly from the stopping part (21) toward an upper end of the body (20) for supporting the pipe (10) and closely contacting the outer peripheral surface of the pipe (10), a tapered part (22) having an inner hollow portion and a diameter gradually narrowed toward the upper end of the body, and an inlet (23) formed in such a manner to be bent at an end of the tapered part (22) in a “ ” form for inserting the pipe (10) fixing chips (24) mounted in the inner hollow portion of the tapered part (22) of the body (20) and formed in such a manner that the upper portion thereof is narrower and the lower portion thereof is wider to correspond to the shape of the tapered part, the fixing chip (24) having at least one bolt hole (26) formed vertically therein; and bolts (25) perforating the inlet side of the body (20) and inserted into the bolt hole (26) of the fixing chip (24), the fixing chips serving as wedges in such a manner that the fixing chips (24) are interposed between the tapered part (22) of the body (20) and the pipe (10) when the bolts are tightened.

### TECHNICAL FIELD

The present invention relates-to a pipe fixing system, and more particularly, to a pipe fixing system, which can easily and rapidly fix and remove a pipe.

### BACKGROUND ART

In general, as examples of structures manufactured by connecting pipe type elements, there are street lights, sign boards, and notice board installed along or on roads, water supply pipes, drain pipes, gas pipes, electric sign boards, advertising towers, and so-on.

However, such pipe fixing system, which adopts a welding method or a screw structure, has a disadvantage in that it requires lots of time and manpower for fixing and removing the pipe structure. In order to connect a pipe type structure, an end of the pipe type structure is welded to the steel board while being in close contact with the steel: board, the triangular iron fragments are welded onto the steel board and the pipe while being in close contact with the steel board and the pipe, and then, the steel board and the iron fragments connected to the pipe are coupled with each other by means of bolts.

A pipe joint for connecting the pipes has lots of welded or screwed connections. If large-scaled pipes are connected, a rubber ring is covered on a pipe connection portion, and a round metallic material is covered thereon, and fixed by means of bolts. Such fixing method has several problems in that it requires lots of time and manpower to install the pipe structure and it is complicated as workers must work in reverse order to dissemble it.

Therefore, installation, repair and maintenance, and dismantlement of a sign board or a street light on the road require an improved fixing method or system, which allows for rapid work. Moreover, also in installation and maintenance of large-scaled waterworks or gas pipes, people demand a rapidly and securely fixing system.

### DISCLOSE OF INVENTION

Accordingly, the present invention has been made in view of the above problems, and it is an object of the present invention to provide a pipe fixing system, which can easily fix or connect and remove a pipe structure without welding or other auxiliary work.

Another object of the present invention is to provide a pipe fixing system, which is economical in installation and maintenance as rapidly fix and remove the pipe structure.

A further object of the present invention is to provide a more firm pipe fixing system and a pipe structure connecting system.

### BRIEF DESCRIPTION OF DRAWINGS

Further objects and advantage of the invention can be more fully understood from following detailed description taken in conjunction with the accompanying drawings in which:

FIG. 1 is a sectional view of a pipe fixing system according to a preferred embodiment of the present invention;

FIG. 2 is a view, seen from an inlet side showing a pipe connection state;

FIG. 3 is an exemplary view of a fixing chip of the present invention;

FIG. 4 is a sectional view of a pipe structure system using the present invention;

FIG. 5 is an exemplary view of a pipe structure connecting system manufactured by uniting two pipe fixing systems of the present invention; and

FIG. 6 is a pipe joint using the present invention.

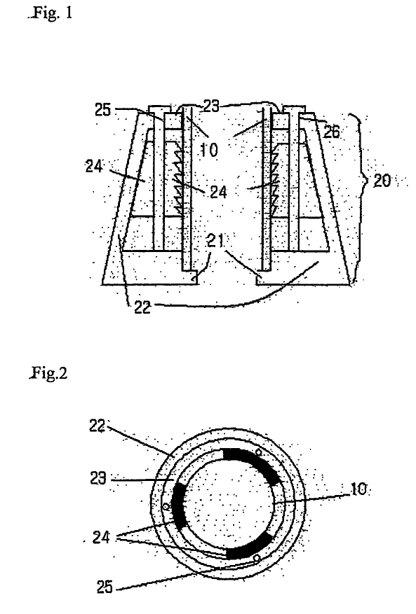

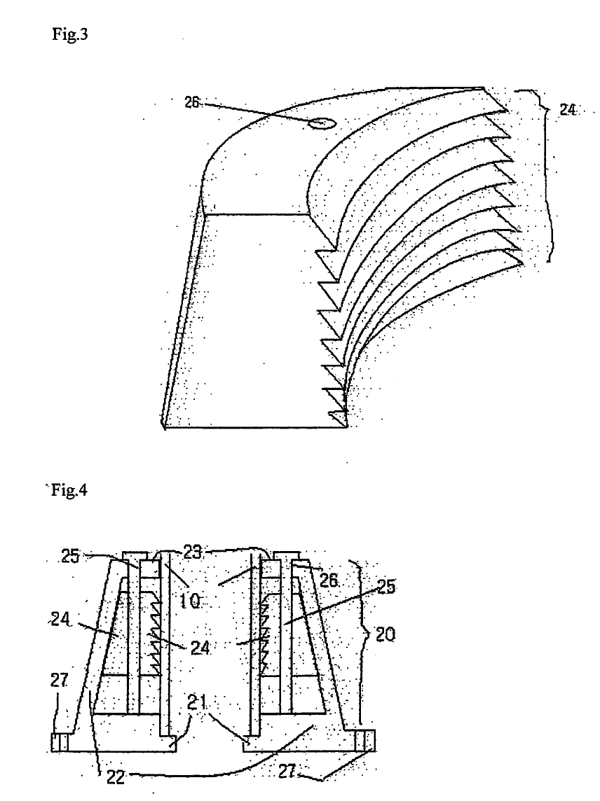

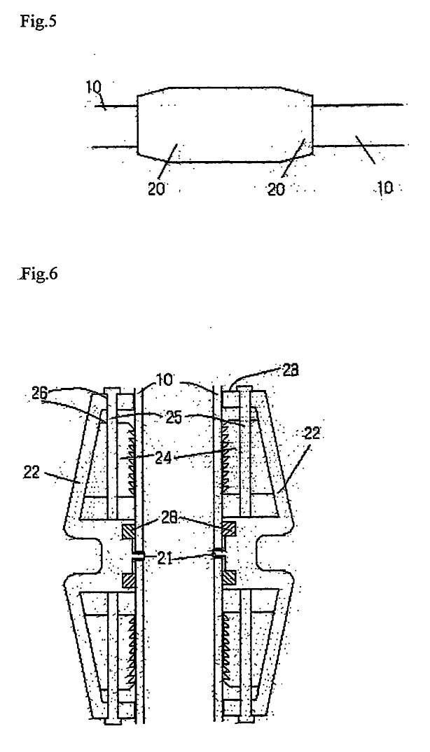

### BEST MODE FOR CARRYING OUT THE INVENTION

The present invention will now be described in detail in connection with preferred embodiments with reference to the accompanying drawings.

A pipe fixing system according to the present invention is a base part of a pipe structure, and is to insert and fix pipes therein.

A body 20 includes a stopping part 21 formed on the lower portion of the inside thereof for stopping movement of the pipe 10 inserted into the body 20, an extended portion extending from the stopping part 21 to a predetermined portion of the body 20 for closely contacting and fixing the pipe 10, a tapered part 22 having an inner hollow portion and an inclined surface gradually narrowed toward an inlet 23, and the inlet 23 formed in such a manner to be bent at an end of the tapered part 22 in a “ [symbol] ” form for inserting the pipe 10 therein.

The inner hollow portion of the tapered part 22 has a number of fixing chips 24 mounted therein, and each fixing chip 24 has a wide lower portion and a narrow upper portion. The upper portion of the fixing chip 24 is connected to a bolt 25 inserted into the inlet 23 from the outside. When the bolt 25 is tightened, the fixing chips 24 are lifted up along the bolt 25, inserted between the inclined surface of the tapered part 22 of the body 20 and the pipe 10, thereby serving a wedge action. The pipe 10 can be securely fixed by the wedge action.

The fixing chip 24 has a bolt hole 26 formed in the inlet side for inserting the bolt therein. Therefore, after the pipe 10 is inserted into the body 10, when a worker tightens the bolt, the fixing chip 24 is pulled upwardly and fixed between the tapered part 22 of the body 20 and the pipe 10, and serves the wedge action.

If the pipe fixing work is finished by tightening the bolt 25, the extended portion extending from the upper portion of the stopping part 21 and the fixing chips 24 hold and fix the pipe 10, so that the pipe can be secured. Particularly, the wedge action of the fixing chips 24 can tighten the pipe 10 with strong power to fix the pipe 10.

To remove the pipe 10 from the pipe fixing system of the present invention, when the bolt 25 is loosened, the fixing chips 24 are lowered downwardly along the tapered surface of the tapered part 24 to the wide portion, and thereby, the pipe 10 can be released from the wedge action of the fixing chips 24 and easily removed from the fixing device.

The present invention can provide very secure effects for fixing and connecting large-scaled pipes as using the bolt for maximizing the wedge effect.

It is preferable that three fixing chips 24 are used to provide a stable structure, and two bolts are mounted to prevent instability, which may be generated during tightening the bolts, due to a laterally long shape of the device. It would be appreciated that a spring is mounted under the fixing chips against possible bolt release so as to provide stability.

The surface hardness of the fixing chip must be higher than that of the body or the pipe to maximize the function of the fixing chip. It is preferable that the extended portion, which is in close contact with the pipe, has a saw toothed shape to maximize friction force, so that the pipe is not moved in-the opposite direction of the insertion direction. Furthermore, the pipe 10 can be fixed more securely if the bolt 25 reaches to a start portion of the tapered part 22.

If the bolt hole 26 of the fixing chip 24 is formed ellaptically in the central direction of the inlet 23, when the fixing chips 24 are moved in the central direction of the body 20, it can reduce stress generated between the bolt 25 and the bolt hole 26.

A horizontal fixing plate 27 is mounted on the lower portion of the fixing device, and the fixing plate 27 has a number of vertical holes for inserting bolt. The pipe fixing system is installed on concrete, which is buried under-the ground, by inserting and fastening the bolts into the vertical holes of the fixing plate 27.

The present invention can be used as a firm I shaped, L-shaped, or T-shaped connecting device for the pipe structures by facing and connecting base portion of at least the two pipe fixing systems.

In addition, a large-scaled pipe joint can be manufactured in such a manner that two pipe fixing systems of the present invention are unite into one piece and a packing 28, such as a rubber ring, is mounted under the tapered part 22. In the pipe joint, the packing 28 provides an air-tight action, and the united pipe fixing systems according to the present invention prevent movement of the pipe 10.

### INDUSTRIAL APPLICABILITY

As described above, the pipe fixing system according to the present invention can easily fix and remove the pipe by a simple screwing action. The pipe is fixed in forward and backward direction of the inserted direction, and when the worker fastens the bolt tightly, the fixing chips can tighten the pipe firmly by the wedge action, so that displacement of the pipe due to rotation of the pipe can be prevented, thereby improving stability of the fixing device.

Furthermore, since the present invention can easily and stably fix and remove the pipe, it can be widely used for permanent fixing and temporary fixing of the pipe.

Moreover, the present invention can easily and rapidly fix the pipe at a small space as not using a welding method.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A pipe fixing system for inserting and fixing a pipe thereto, which forms a base part of a pipe structure, comprising:
a body (20) having a stopping part (21) formed on the lower portion of the inside thereof for stopping the pipe (10) inserted into the body. (20) an extended portion extended partially upwardly from the stopping part (21) toward an upper end of the body (20) for supporting the pipe (10) and closely contacting the outer peripheral surface of the pipe (10), a tapered part (22) having an inner hollow portion and a diameter gradually narrowed toward the upper end of the body, and an inlet (23) formed in such a manner to be bent at an end of the tapered part (22) in a “ [symbol] ” form for inserting the pipe (10);
fixing chips (24) mounted in the inner hollow portion of the tapered part (22) of the body (20) and formed in such a manner that the upper portion the thereof is narrower and the lower portion thereof is wider to correspond to the shape of the tapered part, the fixing chip (24) having at least one bolt hole (26) formed vertically therein; and
bolts (25) perforating the inlet side of the body (20) and inserted into the bolt hole (26) of the fixing chip (24), the fixing chips serving as wedge in such a manner that the fixing chips (24) are interposed between the tapered part (22) of the body (20) and the pipe (10) when the belts are tightened.

2. The pipe fixing system according to claim 1, wherein the body (20) includes a fixing plate (27) mounted on the lower 9 portion thereof and extending to the outside in such a manner to be fixed on concrete by means of bolts.

3. A pipe structure connecting system, comprising at least two pipe fixing systems, each pipe fixing system including:
a body (20) having a stopping part (21) formed on the lower portion of the inside thereof for stopping the pipe (10) inserted into the body (29), an extended portion extended partially upwardly from the stopping part (21) toward an upper end of the body (20) for supporting the pipe (10) and a closely contacting the outer peripheral surface of the pipe (10), a tapered part (22) having an inner hollow portion and a diameter gradually narrowed toward the upper end of the body, and an inlet (23) formed in such a manner to be bent at an end of the tapered part (22) in a “ [symbol] ” form for inserting the pipe (10);
fixing chips (24) mounted in the inner hollow portion of the tapered part (22) of the body (20) and formed in such a manner that the upper portion thereof is narrower and the lower portion thereof is wider to correspond to the shape of the tapered part, the fixing chip (24) having at least one or more bolt holes (26) formed vertically therein; and
bolts (25) perforating the inlet side of the body (20) and inserted into the bolt holes (26) of the fixing chip (24), the fixing chips serving as wedges in such a manner that the fixing chips (24) are interposed between the tapered part (22) of the body (20) and the pipe (10) when the bolts are tightened,
wherein the at least two pipe fixing systems are connected to each other and integrated with each other an the inlets (23) of the pipe fixing systems are arranged in different directions.

4. A pipe joint for connecting pipes, comprising at least two pipe fixing systems, each pipe fixing system including:
a body (20) having a stopping part (21) formed on the lower portion of the inside thereof for stopping the pipe (10) inserted into the body (20), an extended partially upwardly from the stopping part (21) toward an upper end of the body (20) for supporting the pipe (10) and closely contacting the outer peripheral surface of the pipe (10), a tapered part (22) having an inner hollow portion and a diameter gradually narrowed toward the upper end of the body, and an inlet (23) formed in such a manner to be bent at an end of the tapered part (22) in a “ [symbol] ” form for inserting the pipe (10);
fixing chips (24) mounted in the inner hollow portion of the tapered part (22) of the body (20) and formed in such a manner that the upper portion thereof is narrower and the lower portion thereof is wider to correspond to the shape of the tapered part, the fixing chip (24) having at least one bolt hole (26) formed vertically therein; and
bolts (25) perforating the inlet side of the body (20) and inserted into the bolt hole (26) of the fixing chip (24), the fixing chips (24) serving as wedges in such a manner that the fixing chips (24) are interposed between the tapered part (22) of the body (20) and the pipe (10) when the bolts are tightened;
and wherein the at least two pipe fixing system are connected to each other and integrated with each other and the inlets (23) of the pipe fixing system are arranged in different directions, and rubber packings (28) are embedded below the tapered parts (22) of the two pipe fixing system for maintaining sealability.
